(19) United States
(12) Patent Application Publication
(10) Pub. No.: US 2019/0051032 A1
(43) Pub. Date: Feb. 14, 2019

(54) PERSONAL LIFE STORY SIMULATION SYSTEM

(71) Applicant: VIVHIST INC., Hacienda Heights, CA (US)

(72) Inventors: Ting Chu, Hacienda Heights, CA (US); Jiancheng Xu, Hacienda Heights, CA (US)

(21) Appl. No.: 16/079,889

(22) PCT Filed: Feb. 24, 2017
(86) PCT No.: PCT/US2017/019444

§ 371 Date: Aug. 24, 2018

Related U.S. Application Data
(60) Provisional application No. 62/299,391, filed on Feb. 24, 2016.

(51) Int. Cl. G06T 13/40; G06T 19/00

(52) U.S. Cl. CPC G06T 13/40; G06T 2200/24; G06T 19/006

(57) ABSTRACT

A system for generating an animated life story of a person is shown. The system may capture an image of the person's face and generate a computer-animated simulation of the person's face. The computer-animated simulation of the person's face may be superimposed upon a computer-generated based on personal historical data of the person so that a computer-generated life story of the person from an earlier period of time to the present may be generated as a movie or slideshow.

### CROSS-REFERENCE TO RELATED APPLICATIONS

This application claims priority to U.S. Prov. Pat. App. Ser. No. 62/299,391, filed on Feb. 24, 2016, the entire contents of which is expressly incorporated herein by reference.

### STATEMENT RE: FEDERALLY SPONSORED RESEARCH/DEVELOPMENT

Not Applicable

### BACKGROUND

The various embodiments and aspects described herein relate to a personal life story simulation system.

In today's electronic world, people create slideshows of their life. In order to do so, they will aggregate photographs of themselves, friends and family and places that they have been in order to create a story of themselves through still photos and/or videos. If the person has a video of themselves, they may interject these videos into the slideshow when appropriate or create a series of videos that are spliced together to create the story of themselves. However, not everyone has photos and videos of themselves or of their friends and families or places that they have been to in order to create the story. Older people may not have photos and videos of their childhood. For this reason, not everyone will be able to create a story of themselves with the videos and photos that they have at hand.

Accordingly, there is a need in the art for a system and method for creating a story of a person.

### BRIEF SUMMARY

An electronic platform is disclosed herein which allows a user to customize a simulated life story with his or her facial features. The electronic platform takes a picture of a face of the user then animates the picture and superimposes the animated facial feature onto an animated person into scenes of a movie or slideshow selected based on personal historical data of the user. By doing so, even if the user does not have a photo or video of themselves in a particular place or time period (e.g. childhood), the simulation of the life story of the user is generated by the personal historical data provided by the user and the facial photo of the user which is superimposed onto a computer generated character or body so that the computer generated character resembles the user.

More particularly, a computer implemented method for aggregating one or more facial images of the user, historical data about the user's current and past life situation and merging images and the historical data to generate a simulated story about the user, the method comprising the steps of collecting historical user data with a software application; collecting one or more facial images of the user; animating the one or more facial images; merging the animated facial image of the user onto an animated character in an animated scene based on the historical user data; and generating a slideshow or movie clip from the merged animated facial image and animated scene. The length of the slideshow or movie clip depends on the amount of information obtained from the user. In the method, the animated scene may be based on stock images of places, occupations, sports and living or working environments.

The method may further comprise the steps of altering the animated facial image of the user to account for age of the user. The altering step may include the step of digitally smoothing facial features of the user or adding wrinkles to an animated facial image of the user to make the user appear younger or older.

In the method, the animated scene may include premade animated scenery.

The method may further comprise steps of presenting a preselected scene from the slideshow or movie clip; and providing an option to include customized information into select areas of the scene on buildings, people and/or objects.

The option may be a drop down list of trademarks, words, images or combinations thereof. In the method, the customized information added into the preselected scene may be transferred to other scenes in the slideshow or movie clip.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates a schematic view of a personal life story simulation system;

FIG. 2 illustrates a screen of a smart phone used to acquire a headshot photo image of the user;

FIG. 3 illustrates the screen of the smart phone after the headshot photo image of the user is acquired and allows a user to confirm that the headshot photo image is acceptable or rejected;

FIG. 4 illustrates the screen of the smart phone allowing the user to indicate whether the user is a male or female;

FIG. 5 illustrates the screen of the smart phone showing a body of a computer generated character which can be altered by the user so that the computer generated character reflects the body type of the user;

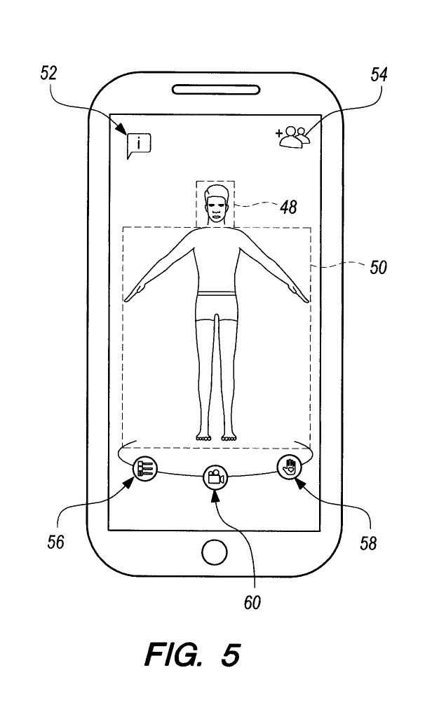

FIG. 6 illustrates the screen of the smart phone showing an age profile screen;

FIG. 7 illustrates the screen of the smart phone showing a childhood memories profile screen;

FIG. 8 illustrates the screen of the smart phone showing a teenhood memories profile screen;

FIG. 9 illustrates the screen of the smart phone showing an adulthood memories profile screen;

FIG. 10 illustrates the screen of the smart phone showing a senior hood memories profile screen;

FIG. 11 illustrates the screen of the smart phone showing a city profile screen;

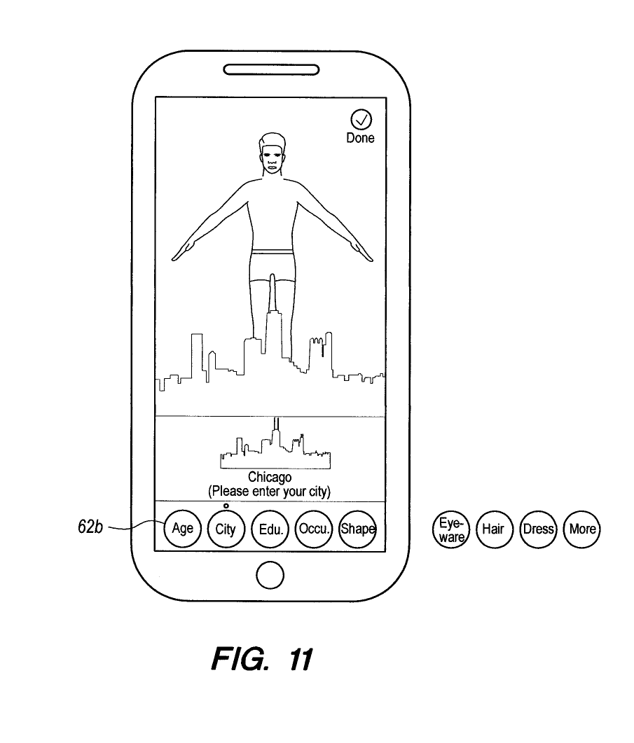

FIG. 12 illustrates the screen of the smart phone showing an education profile screen;

FIG. 13 illustrates the screen of the smart phone showing an occupation profile screen;

FIG. 14 illustrates the screen of the smart phone showing a shape profile screen;

FIG. 15 illustrates the screen of the smart phone showing a personal or business advertisement preview screen;

FIG. 16 illustrates the screen of the smart phone showing a play story screen; and

FIG. 17 illustrates the screen of the smart phone showing a story video clip.

### DETAILED DESCRIPTION

Referring now to the drawings, a computer implemented method for aggregating one or more facial images of the user, historical data about the user's current and past life situation and merging images and the historical data to generate a simulated story about the user is disclosed. An application on a mobile device (e.g., smart phone) 10 or desktop computer may guide the user in collecting the images and the historical data from the user. The application may transmit the images and the historical data about the user to a cloud-based server 12. The images and historical data about the user may be stored in a user data repository 14 on the cloud based server 12. Based on the historical data entered by the user, the server 12 selects the appropriate image(s) and videos that correspond to the user's life. The server 12 superimposes the facial images of the user onto images and videos and generates a movie or slideshow 18 of the user's life.

The images and videos may be created virtually or be from third-party stock images and video content services 16 (e.g., bigstockphoto.com or istockphoto.com). The server may have a repository of images, stock images, images generated in house, videos, stock videos and videos generated in-house.

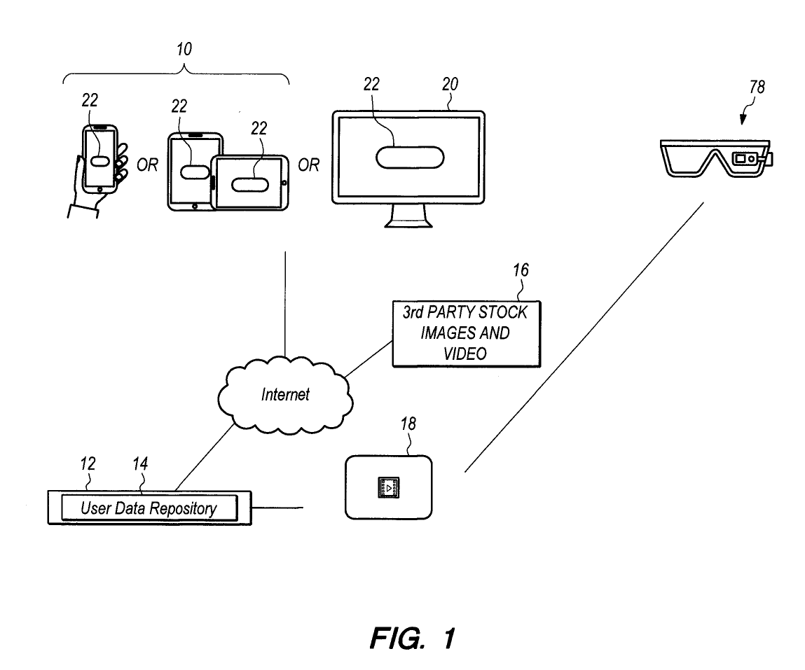

Referring now to FIG. 1, mobile devices 10 in the form of a smart phone or tablet are shown. Additionally, a desktop computer 20 is also shown. The computer implemented method may be initiated by launching an app on the smart phone or tablet computer 10 or starting a program on the desktop computer 20. Upon start of the application, a start button 22 may be shown which guides the user through steps to aggregate one or more images of the user and historical data about the user so that a movie or slideshow 18 of the user's life may be simulated and shown to the user or another person.

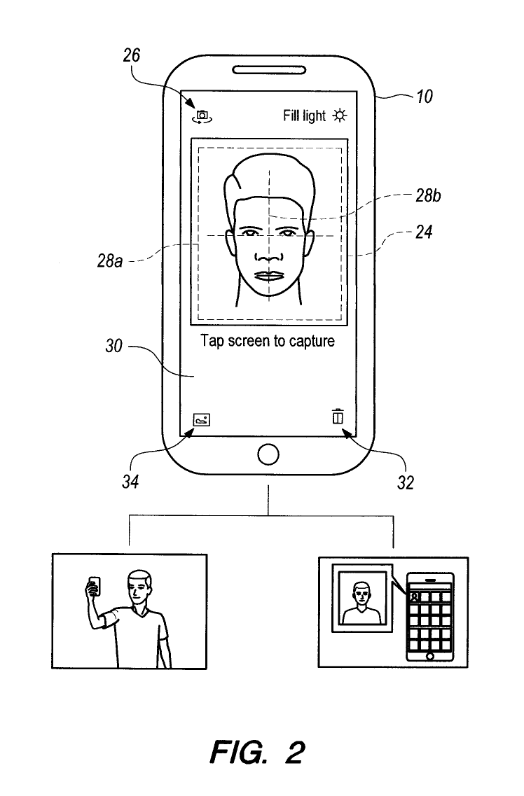

Upon clicking the start button 22, the first step is to acquire a headshot photo image of the user. Referring to FIG. 2, the application displays a screen and a camera image section 24 that obtains images from the front or rear camera of the mobile device 10. The application sets the front camera as the default camera. If the user uses the back camera, the user can depress the front and back camera switch button 26 to switch between the front and back cameras. The camera image section 24 may have a crosshair 28a, b which instructs the user to align the user's eyes along a horizontal crosshair 28a and the user's nose along a vertical crosshair 28b. When the user's face is properly aligned to the crosshairs 28a, b, the user may tap on the screen 30 to capture the image shown in the camera image section 24. Before capturing the image, the user may depress the fill light button 30 in order to adjust lighting of the person. The fill light option 30 may be turned on only when using the back camera so that the camera's light can illuminate the user's face. This is useful when a friend of the user utilizes the mobile device 10 to capture the facial image of the user. If the user is capturing his or her facial image by way of a selfie, then the user may depress the front and back camera switch button 26 to access the front camera. If the captured image is unsatisfactory, the user may depress the cancel button 32. Alternatively, the user may upload a facial image of the user by way of the photo gallery on the mobile device 10.

It is also contemplated that the facial image may be captured by uploading the facial image of the user from a desktop computer 20. The desktop computer 20 may also be used to capture the facial image of the user. In particular, the desktop computer 20 may have a camera which can capture the facial image of the user.

The facial images and the historical data entered in by the user may be associated with a unique identifier stored on the user data depository on the server 12. As such, this provides versatility and ease of use to the user so that the user can switch between mobile devices 10 and computers 20 as the user uploads images and enters historical data to complete the user's profile and all of the required and desired facial images and historical data about the user. The facial image can be captured by the mobile device 10. The user can log out and upload and associate historical data about the user to the unique identifier on the desktop computer 20, and vice versa. In this regard, the user must login to the system in order to create the unique identifier which will store all of the information including but not limited to the facial images and the historical data of the user on the server 12.

In order to capture or upload photos from the mobile devices 10 photo gallery, the user may depress a photo gallery button 34 which accesses the mobile devices 10 photo gallery and allows the user to select a photo to be uploaded to the user data repository 14 on the server 12 through the app of the mobile device 10.

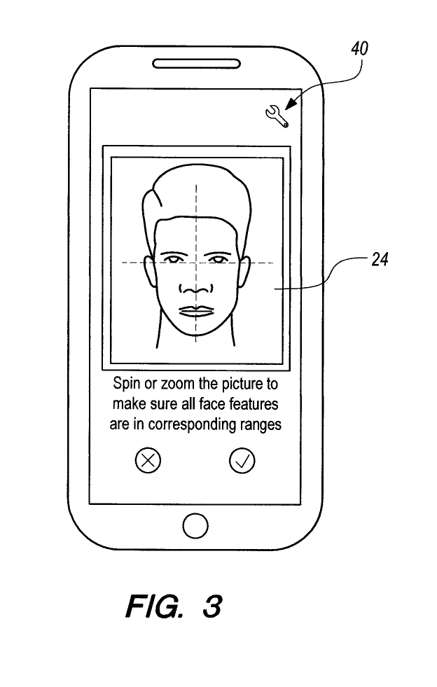

After tapping the screen 30 to capture the image, the user is asked to either cancel or confirm the facial image shown in the camera image section 24 by depressing the cancel button 36 or the confirm button 38 as shown in FIG. 3. The user may also depress a support and help button 40 if the user is having difficulty inputting data and uploading images or utilizing the application.

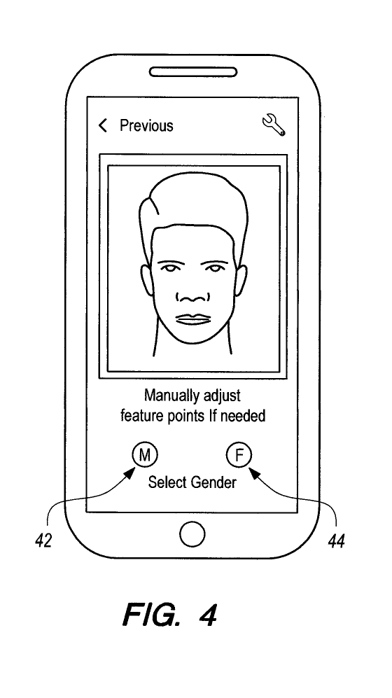

Upon depressing the confirm button 38, the user is led to the screen shown in FIG. 4. The user selects his or her gender male or female by depressing either the male button 42 or the female button 44. The user can also retake the photo by depressing the previous button 46 which leads the user back to the image capture screen shown in FIG. 2. Upon depressing either the male or female buttons 42, 44, the user's facial image 48 is superimposed upon a body 50. The user can depress an about and information button 52 to find out more about the application, and add story character button 54. The user may also depress a complete user profile button 56 and a volunteering function button 58. The user may also depress a play user's life story movie button 60 when the user has inputted a sufficient amount of historical data about the user and taken the facial image discussed above.

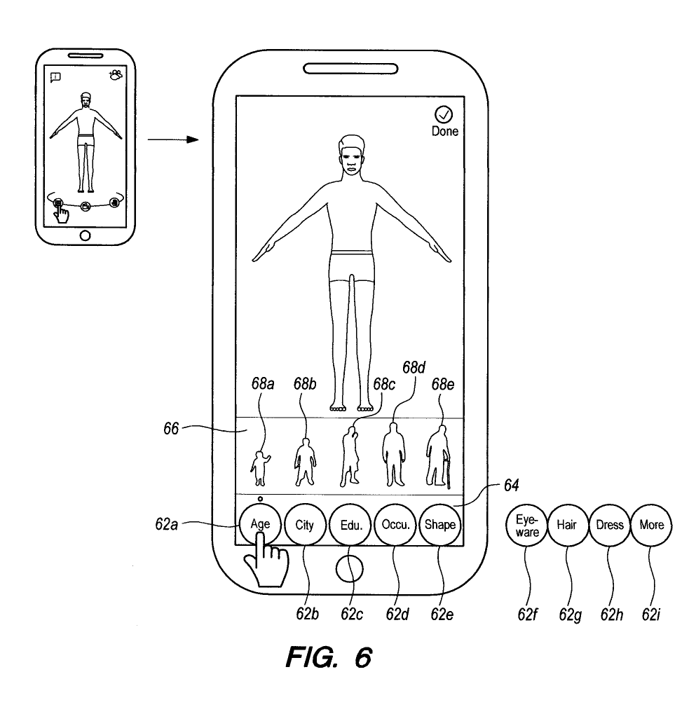

Upon depressing the complete user profile button 56, one or more data categories 62a-n are displayed on the screen, as shown in FIG. 6. Data categories 62a-e are shown. Data category 62a is for age. Data category 62b is for the city. Data category 62c is for education. Data category 62d is for occupation. Data category 62e is for physical shape. Additional data categories may be shown by swiping the screen from right to left in the data categories section 64 of the screen of the mobile device 10. Data categories 62f and following will be shown on the screen. Data category 62f is for eyewear. Data category 62g is for hair. Data category 62h is for dress or clothing. Additional data categories may be incorporated into the computer implemented method and shown by depressing data category 62i.

Upon depressing data category 62a for age, a visual representation of various age stages of a person's life is shown immediately above the data categories section 64 in the category options section 66. In the category options section 66, a toddler 68a, grade school 68b, teen 68c, adult 68d and senior 68e images are shown. The user may depress one of the images to enter historical data about that age of the user.

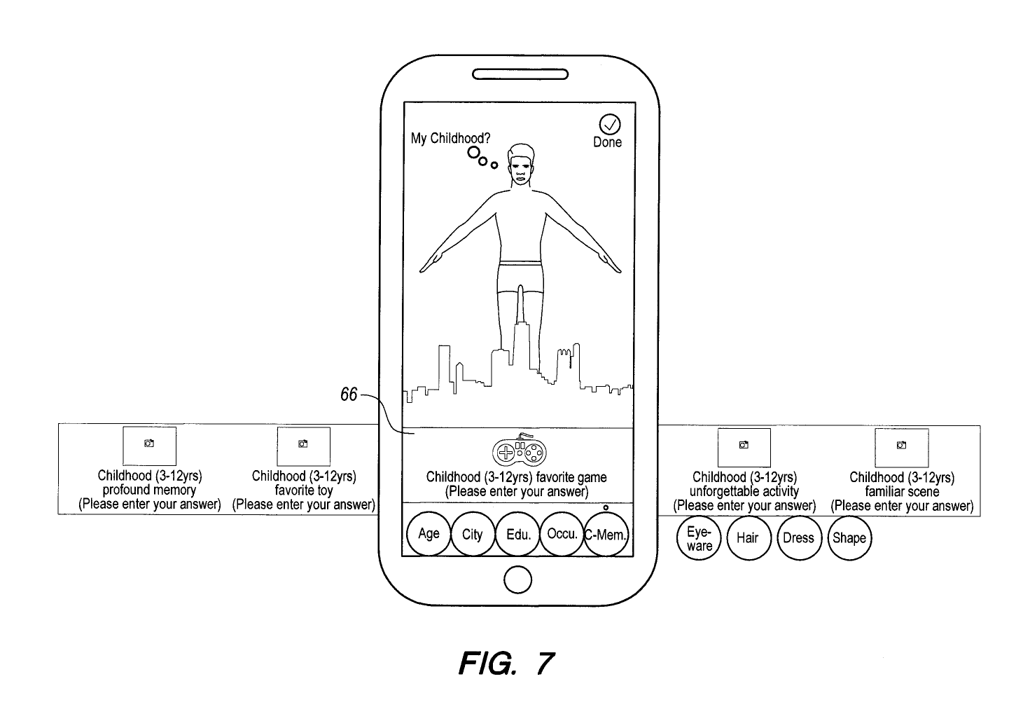

By way of example and not limitation, the user may depress the childhood image 68b at which time the user will be directed to the screen shown in FIG. 7. In the category options section 66, the user can enter in various information (i.e., historical data) that is relevant to that age. By way of example and not limitation, the user can enter in the favorite game of the user when he or she was 3 to 12 years old. By swiping left or right in the category options section 66, other data can be entered in such as a profound memory, favorite toy, unforgettable activity or familiar scene.

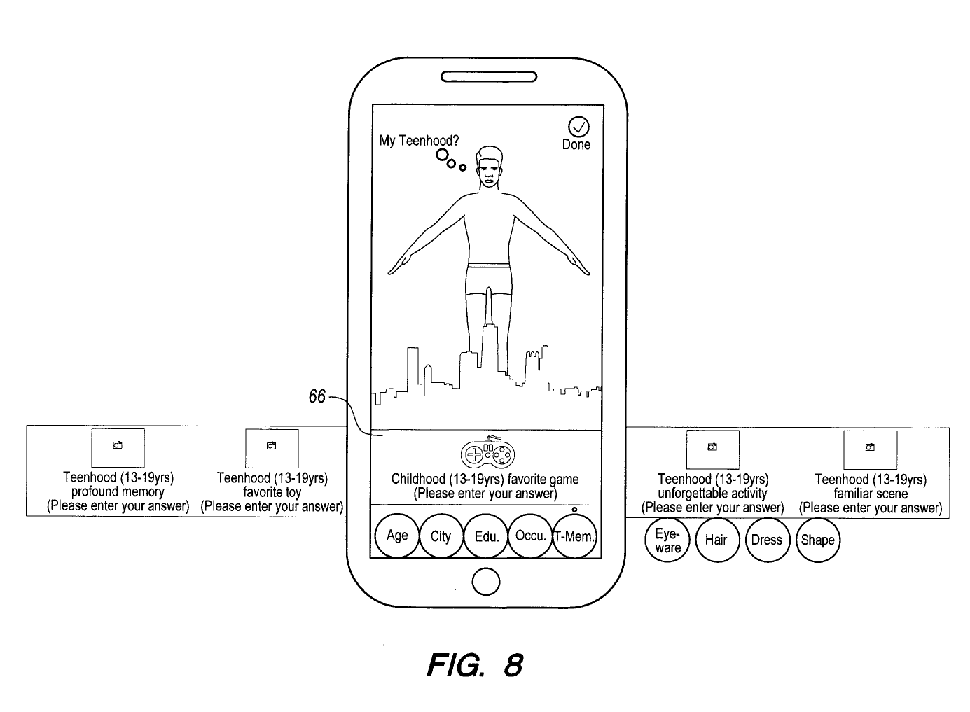

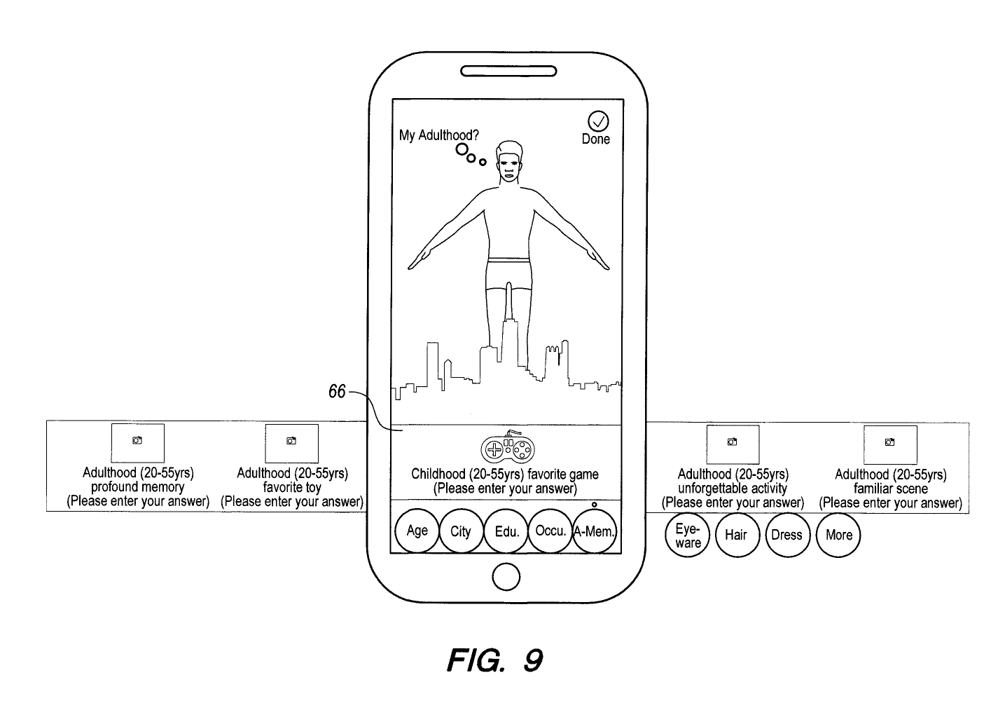

Referring back to FIG. 6, the user may depress the teen image 68c and be directed to the screen shown in FIG. 8. In the category options section 66, the user may enter various information that is relevant to that age. By way of example and not limitation, the user may enter in the user's favorite game, favorite toy, profound memory, unforgettable activity and familiar scene. These other items may be entered into by swiping left and right on the screen in the category option section 66. Referring back to FIG. 6, the user may now depress the adult image 68d and be directed to the screen shown in FIG. 9. In the category options section 66, the user may enter in various information relevant to their age. By way of example and not limitation, the user may enter in the user's favorite game, favorite toy, profound memory, unforgettable activity or familiar scene.

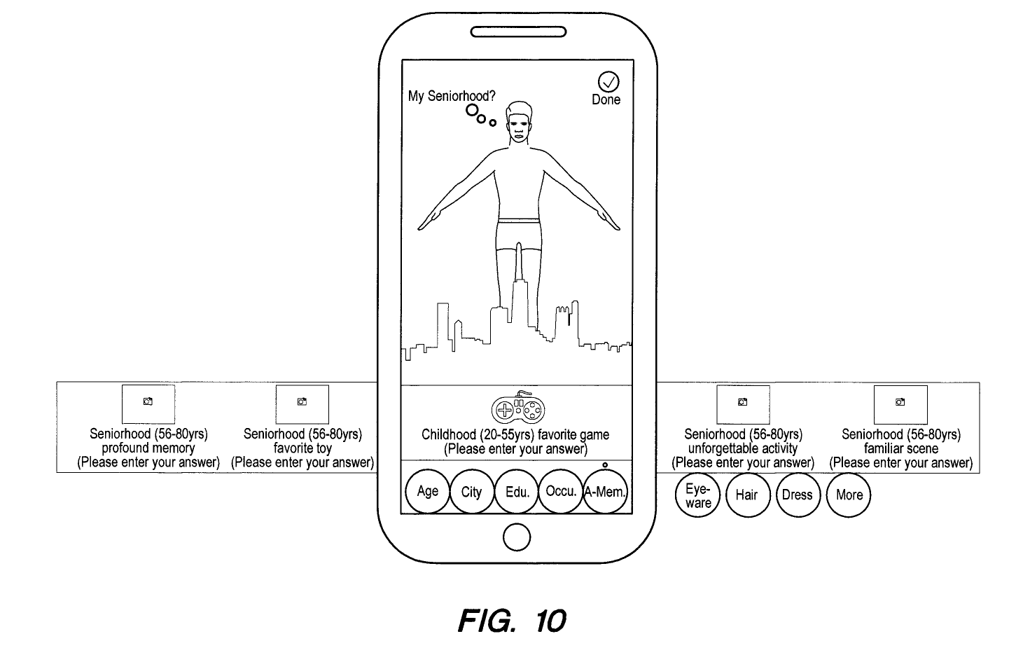

The user may enter in information related to the user for the infant age by depressing infant image 68a or senior age by depressing senior image 68e which leads the user to the options shown in FIG. 10.

For each age range, the user may enter historical data regarding city, education, occupation, memory as discussed, eyewear, hair, dress, shape.

The user may also depress the city data category 62b. In the category option 66, the user may enter in the city name that the user lives in. The user may click on the “please enter your city” link and enter in the city in which the user lives in. The computer implemented method may request the user to enter in one or more cities based on the user's age.

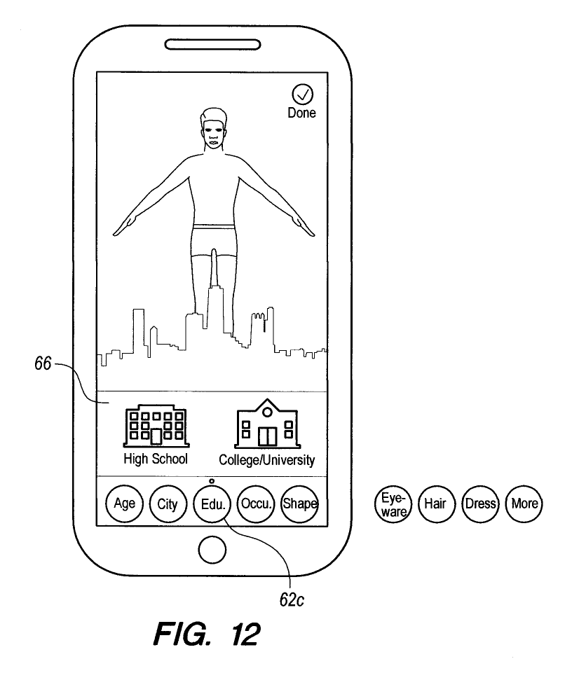

Referring now to FIG. 12, the user may depress the data category 62c and be provided with options to enter in the user's high school name and college or university name Although not shown, the user may be presented with the option to enter in the user's intermediate school name, grade school name and higher education names. This may be done by allowing the user to slide left and right in the category options section 66.

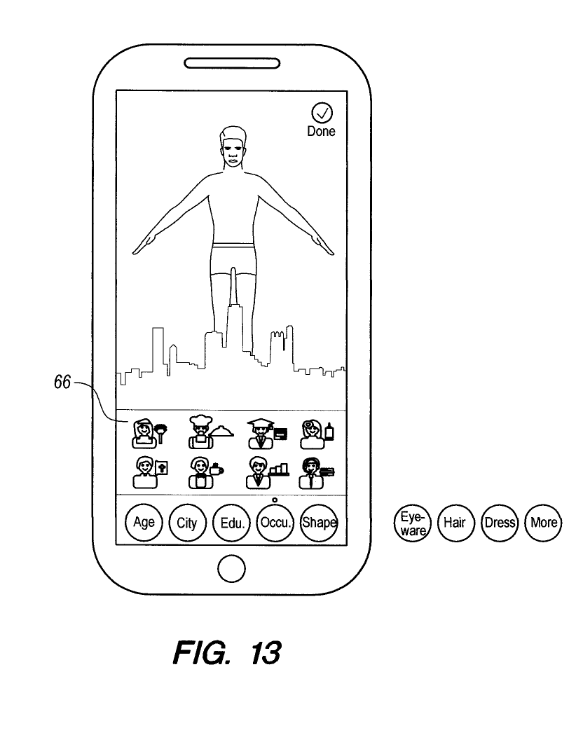

Referring now to FIG. 13 the user may depress the data category 62d to specify his or her occupation. The occupation may be selected by visual representation as shown in FIG. 13 in the category option section 66 or may be a textual entry by way of the on screen keyboard.

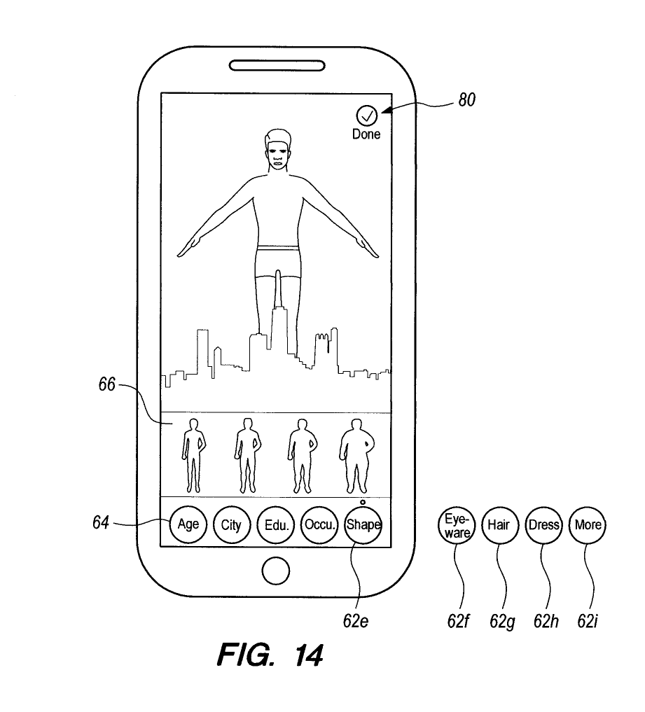

Referring now to FIG. 14 the user may depress data category 62e upon which the category option section 66 illustrates a variety of body types for the gender of the user. The user may select the body type most representative of the user. The user may tap the done button 68 which saves the historical data of the user in the user data repository 14 on the server 12.

As discussed above, the user may access more data categories 62f-n by swiping in the data categories of section 64 right to left. Upon depressing these additional data category buttons 62f-n, the user is presented with the option to insert more historical data about the user regarding these other types of categories.

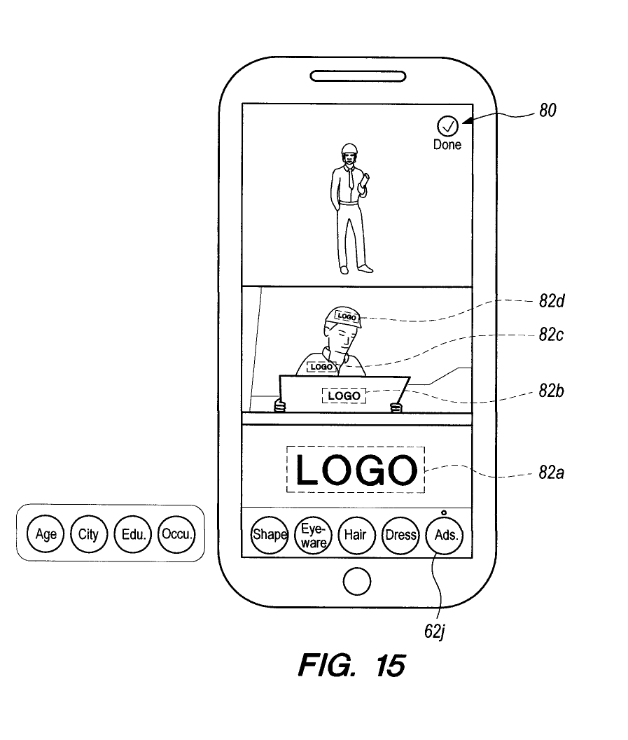

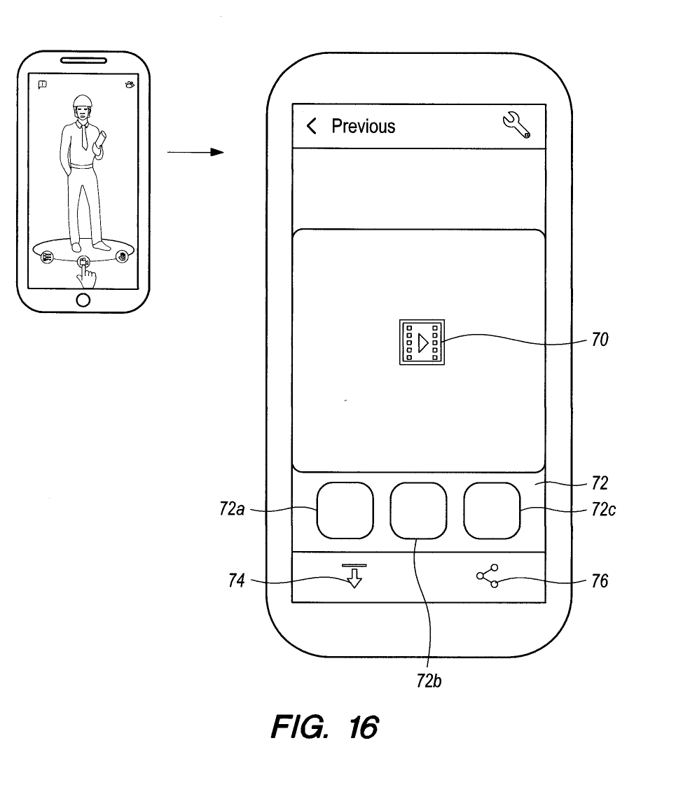

Referring now to FIG. 15, a scene from the simulated user life story movie and/or slideshow is shown. In this regard, the user may include one or more logos within the scene. The scene may be displayed by depressing the button 62j. Optionally, this feature may be a member only option wherein the member be offered membership if the user provides his or her contact information (e.g, name, address, phone number, email address, other personal information and/or combinations thereof). As a further option, the member may be required to also pay for the ability to place the logos, trademarks, words, customized words and/or graphics into the scene. Additionally, companies, cities, places, people may pay for the option of having their trademark, logo, information show up and be in the option list presented to the user so that the company specific information is placeable into the scene. Upon depressing the ads icon 62j, one or more scenes from an animated slideshow or movie may be presented to the user and the user may be given the option to include logo(s) or other information identified above in the slideshow or movie. The user can touch areas 82a, b, c, d-n on the screen to input the company specific information. The user can type in a trademark. Alternatively, the user may be presented with options which retrieved information from a database of company specific information that can be inserted into the areas 82a-n. The options on the company specific information may pop up as a list of options for the user to select any one of the various possible company specific information that can be inserted into the areas 82a-n. After the user has customized the scene, the user may then depress a done button 80. The user may be presented with additional screens to input additional company specific information into the scene. Alternatively, the user may depress the area 82a which will bring up a list of options that can be inserted into the scene. The user may select one of those options. The user may also type in information into the area 82a. When the user selects one of the options or types in information into the area 82a either through the keyboard, photo gallery or option list, the selected information is propagated into the scene in areas 82b, c, d-n. When the user is finished with inputting trademarks and logos into one or more scenes of the movie or slideshow, the user may depress done button 80, at which point the user will be directed to the screen shown in FIG. 16.

The user may view the simulated user life story by depressing the done button 68 at any time during the process of entering the user data discussed above. If insufficient amount of data has been entered, then the done button 80 may be inactivated and shaded out to indicate the same to the user. Once sufficient user historical data has been entered into the application and saved to the user data repository 14, the done button 80 may be activated. Upon depressing the done button 68, the user is led to the screen shown in FIG. 16. The simulated user life story movie and/or slideshow is shown on the screen.

The user may select the movie or slideshow by depressing the play button 70 the movie or slideshow is simulated and that the actual photo of the user's face is incorporated into stock images and video is retrieved from third-party stock images and video services 16 and compiled into a slideshow that depicts the chronological life of the user. Based on the information provided by the user, additional movies or slideshows can be generated and presented to the user in the movie options section 72. In FIG. 16, three different movie options 72a-c are shown but additional ones can also be presented to the user in the movie options section by allowing the user to swipe left and right. The movie clips may be downloaded and shared by depressing the download button 74 or the share button 76.

In generating the movie clip or slideshow of the user, the facial images of the user may be altered to match the user's age. By way of example and not limitation, the user may capture current facial images of the user when he or she is middle aged. The facial image of the user at their current age is not in the slideshow or movie. However, the facial images of the user are transformed into a computer animated face and it is the computer animated face that is used in the slideshow or movie. Moreover, the computer animated face of the user may be altered or computer-generated in order to make the user look younger to fit the particular age of the user depicted in a particular scene. For example, if the user is an adult, the computer animated image may be altered to resemble the user as a child and that childlike computer animated image would be used for childhood memories in the slideshow or movie. Rather, the facial image is altered to a more youthful appearance so that the youthful appearing facial image of the user is merged onto the background images for that particular timeframe. The facial image of the user is altered to the appropriate age of the user.

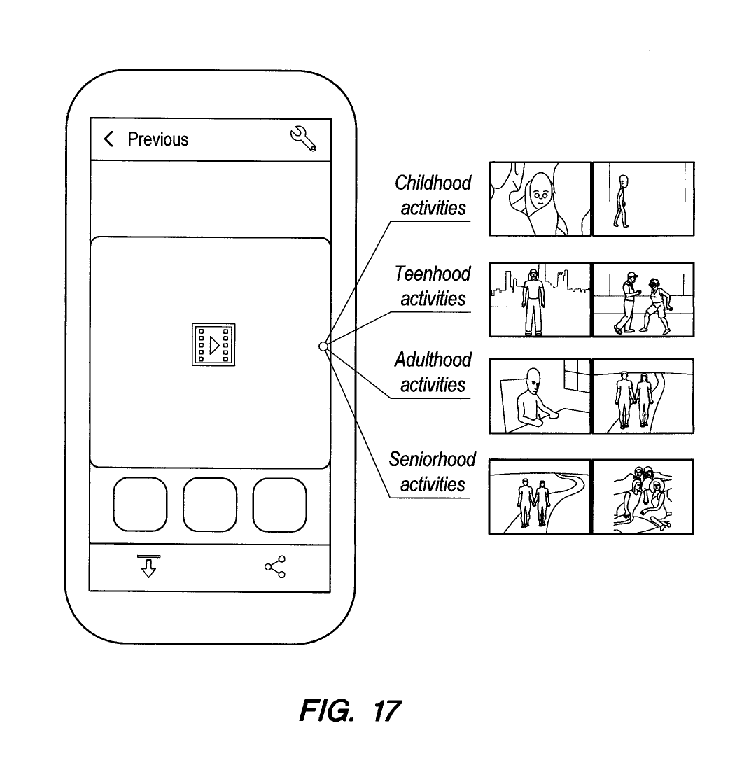

FIG. 17 shows a series of still images that are chronologically aggregated and assembled in the user's life story by way of simulation.

The video or movie may also be displayed on a virtual reality eyewear 78 that allows the user to scan the scene left and right.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A computer implemented method for aggregating one or more facial images of the user, historical data about the user's current and past life situation and merging images and the historical data to generate a simulated story about the user, the method comprising the steps of:
collecting historical user data with a software application;
collecting one or more facial images of the user;
animating the one or more facial images;
merging the animated facial image of the user onto an animated character in an animated scene based on the historical user data;
generating a slideshow or movie clip from the merged animated facial image and animated scene.

2. The method of claim 2 wherein the animated scene is based on stock images of places, occupations and sports.

3. The method of claim 1 further comprising the steps of altering the animated facial image of the user to account for age of the user.

4. The method of claim 3 wherein the altering step includes the step of digitally smoothing facial features of the user or adding wrinkles to an animated facial image of the user to make the user appear younger or older.

5. The method of claim 1 wherein the animated scene includes a premade animated scenery.

6. The method of claim 1 further comprising steps of:
presenting a preselected scene from the slideshow or movie clip;
providing an option to include customized information into select areas of the scene on buildings, people and/or objects;

7. The method of claim 6 wherein the option is a drop down list of trademarks, words, images or combinations thereof.

8. The method of claim 6 wherein the customized information added into the preselected scene is transferred to other scenes in the slideshow or movie clip.
